(19) United States
(12) Patent Application Publication
(10) Pub. No.: US 2005/0042423 A1
(43) Pub. Date: Feb. 24, 2005

(54) Antiglare film and production method of antiglare film

(75) Inventor: Hisao Arai, Kanagawa (JP)

Correspondence Address: SUGHRUE MION, PLLC, 2100 PENNSYLVANIA AVENUE, N.W., SUITE 800, WASHINGTON, DC, 20037, US

(73) Assignee: FUJI PHOTO FILM CO., LTD.

(21) Appl. No.: 10/918,405

(22) Filed: Aug. 16, 2004

(30) Foreign Application Priority Data
Aug. 18, 2003 (JP) P.2003-294275

(51) Int. Cl. B32B 1/00

(52) U.S. Cl. 428/141; 428/156

(57) ABSTRACT

To provide a production method which can realize easy production of an antiglare film an antiglare film 10 is produced by performing planar scanning with a laser light on a surface of the antiglare film, wherein the planar scanning comprises: a main-scanning in X direction; and a sub-scanning in Y direction; and controlling an output of the laser light when the main scanning is performed, so as to form the irregular surface upon irradiation with the laser light. In this production method, a beam diameter of the laser light is changed randomly at each irradiation portion of the laser light (in FIGS. 1A-1B, each lattice point of the lattice 14), whereby the output of laser light is controlled.

### BACKGROUND OF THE INVENTION

1. Field of the Invention

The present invention relates to an antiglare film having an irregular surface.

2. Background Art

Conventionally, an antiglare film is used for reducing reflection of a fluorescent light or the like on the screen of a liquid crystal display and the like. This antiglare film is produced by forming concave or convex shapes randomly arranged on a surface of the film. As for the formation method of these shapes, in general, particles having an appropriate size are incorporated into the vicinity to the inner surface of the film to form a convex portion in a region where the particle is present and a concave portion in a region where the particle is not present, and thereby concave or convex shapes is randomly formed on the surface. Other than this, there are known, for example, a method of coating a thermosetting resin or the like on a master processed to have a surface having concave or convex shapes by laser irradiation, electron beam, photolithography or the like and separating the master, and a method of transferring a concave or convex structure to a film by using the above-described master as the embossing plate.

Also, a film having antiglare property is sometimes realized by forming concave or convex shapes not randomly but according to a predetermined regularity (see, for example, JP-A-2002-14211 (the term “JP-A” as used herein means an “unexamined published Japanese patent application”)).

### SUMMARY OF THE INVENTION

In these conventional antiglare films, concave or convex portions are randomly arranged to prevent glaring or generation of color due to interference of light, but it is difficult to design a film having a random arrangement of concave or convex portions. In the case of randomly forming concave or convex portions on a surface by irradiating the surface with a laser light or the like, it is difficult to completely randomly arrange concave or convex portions, because the position irradiated with laser light is fundamentally changed by the two-dimensional horizontal scanning and vertical scanning. Also in the technique of JP-A-2002-14211, the concave or convex shapes is formed according to a predetermined regularity, therefore, positions of the concave and convex portions must be decided with good precision and the production of film is technically difficult.

The present invention has been made under these circumstances and an object of the present invention is to provide a production method which can realize easy production of an antiglare film. Another object of the present invention is to provide an antiglare film which can be easily designed.

The foregoing objects of the invention can be attained with methods and films described below:

The production method of an antiglare film of the present invention is a method for producing an antiglare film having an irregular surface, which comprises:

performing scanning with a laser light on a surface of the antiglare film, wherein the scanning comprises: a main-scanning in a first direction; and a sub-scanning in a second direction orthogonal to the first direction; and

controlling an output of the laser light when the main scanning is performed, so as to form the irregular surface upon irradiation with the laser light,

wherein the controlling is performed by changing at least one of an irradiation area of the laser light, an intensity of the laser light, and an irradiation time of the laser light, randomly at each irradiation position of the laser light.

According to this production method, an antiglare film can be produced by a simple output control of a laser light.

The antiglare film of the present invention is an antiglare film having an irregular surface, which comprises a surface having a plurality of concave portions forming a lattice extending in a first direction and a second direction not parallel to the first direction, wherein each of the plurality of the concave portions have a variation in size. Also, each size of the plurality of the concave portions represents at least one of an opening area and a dimple depth in each of the plurality of the concave portions.

The antiglare film of the present invention is an antiglare film having an irregular surface, which comprises a surface having a plurality of convex portions forming a lattice extending in a first direction and a second direction not parallel to the first direction, wherein each of the plurality of the convex portions have a variation in size. Also, each size of the plurality of the convex portions represents at least one of a projected area and a protrusion height in each of the plurality of the convex portions.

According to these antiglare films, the antiglare property can be obtained by arranging concave or convex portions in a line, the concave or convex portions having a variation in size, so that the film can be easily designed as compared with the case of forming concave or convex portions at random positions.

According to the present invention, an antiglare film can be easily produced. Also, an antiglare film easy to design can be provided.

### BRIEF DESCRIPTION OF THE DRAWING

FIGS. 1A-1B show an outline constitution of an antiglare film for explaining a first embodiment of the present invention, FIG. 1A shows a cross-section of the antiglare film, and FIG. 1B shows a plan view of the antiglare film.

FIGS. 2A-2B show an outline constitution of an antiglare film according to a second embodiment of the present invention, FIG. 2A shows a cross-section of the antiglare film, and FIG. 2B shows a plan view of the antiglare film.

FIG. 3 shows an outline constitution of an example of the apparatus for use in the production of the antiglare film.

### DETAILED DESCRIPTION OF THE INVENTION

### FIRST EMBODIMENT

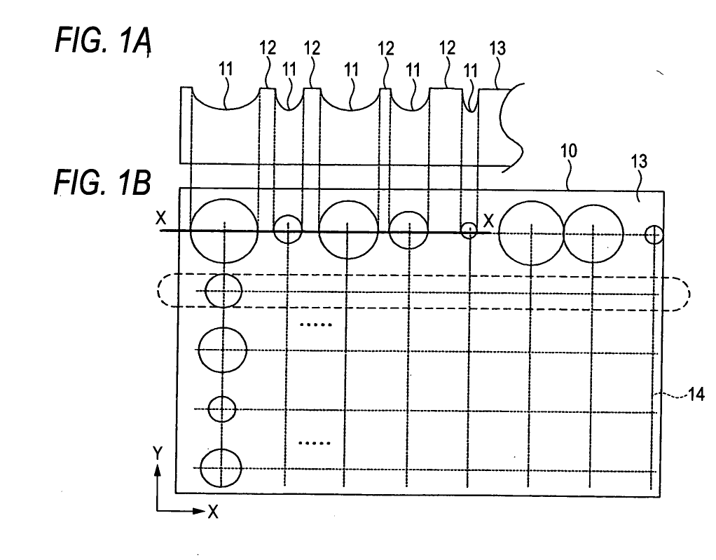

FIGS. 1A-1B show an outline constitution of an antiglare film for explaining a first embodiment of the present invention. FIG. 1A shows a X-X cross-section of the antiglare film (X is showed in FIG. 1B) and FIG. 1B shows a plan view of the antiglare film.

As shown in FIG. 1A, the antiglare film 10 has an irregular surface 13 having nearly conical concave portions 11 and convex portions 12. A concave portion 11 is formed, for example, by irradiation of a laser light. In FIG. 1B, an opening area of the concave portion 11 in the surface 13 is shown by a circle. The concave portions 11 form a lattice 14 on the surface 13, that is, the concave portions 11 are arrayed in a first direction (for example, X direction) and a second direction (for example, Y direction). The circle center (that is the center point of the irradiation area of the laser light) nearly coincides with the lattice point of the lattice 14. The interval between two adjacent lattice points is preferably 1 to 100 aim, more preferably 5 to 20 μm. The circle diameter is preferably 1 to 100 μm, more preferably 5 to 20 μm on average. The concave portions 11 have a variation in size (in FIGS. 1B, the opening area or the circle diameter). Each size of the concave portions 11 is determined by, for example, a random number at each position of the concave portions 11.

In FIGS. 1A-1B, if the concave portions 11 have no variation in size, the antiglare film 10 satisfies two conditions that the concave or convex portions has a regular cross-sectional shape in the linear cross section of the antiglare film 10 and that the same cross-sectional shape of concave or convex portions as the regular cross-sectional shape repeatedly appears in the cross section parallel to the linear cross section, as a result, a color is viewed on the antiglare film 10 due to interference of light.

In the antiglare film 10 of this embodiment, the concave portions 11 have a variation in size and the above-described conditions are not satisfied. Accordingly, when external light entering from the outside is reflected on the surface 13, the interference due to diffraction of the reflected light is resolved and the generation of a color due to interference of light can be suppressed. Furthermore, the light from outside or inside can be diffusively reflected or diffusively transmitted at the surface 13 and therefore, when the antiglare film 10 is superposed on the surface of a display, the viewer of the display can see a glareless and clear image.

In addition, unlike conventional techniques of forming the concave portions 11 at random positions, the concave portions 11 are formed at regular positions and a randomness of concave or convex portions are realized by varying the size of every concave portion 11, so that the design of the antiglare film 10 can be facilitated as compared with conventional antiglare films.

When the concave portions 11 have a variation in size, the size is not limited to the opening area but may be the dimple depth in each of the concave portion 11 or may be both the opening area and the dimple depth. Also, the shape of each concave portion 11 is not limited to a circular cone but may be an arbitrary polygonal cone.

Furthermore, in the description above, the concave portions 11 are formed in a lattice of a rectangular shape on the surface 13 (that is, the concave portions 11 are arrayed in a first direction and a second direction orthogonal to the first direction). The same effect can be obtained as long as there is provided an arrangement where a plurality of concave portions 11 are formed in a straight line extending to a specific direction (for example, X or Y direction) on the surface 13 and a plurality of the straight lines are arrayed in rows in the direction orthogonal to the specific direction. For example, in FIG. 1B, the concave array having a plurality of concave portions 11 (the portion surrounded by a dotted line) may be slipped off to the X direction by ½ pitch with respect to the next array, that is, the concave portions 11 are formed in a lattice of a parallelogram shape (that is, the concave portions 11 are arrayed in a first direction and a second direction not orthogonal to the first direction). The interval between concave portions in the concave array may not be constant in each concave array.

The antiglare film 10 can also be produced by using a known method other than the method of forming concave portions by the irradiation of the laser light.

### SECOND EMBODIMENT

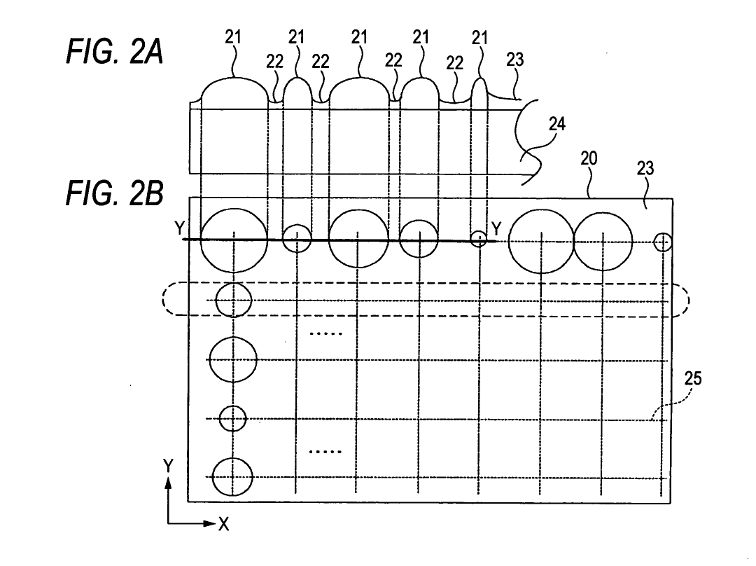

FIGS. 2A-2B show an outline constitution of an antiglare film according to a second embodiment of the present invention. FIG. 2A shows a Y-Y cross-section of the antiglare film (Y is showed in FIG. 2B) and FIG. 2B shows a plan view of the antiglare film.

As shown in FIG. 2A, the antiglare film 20 has an irregular surface 23 having nearly conical convex portions 21 and concave portions 22 formed on a support 24. A convex portion 21 is formed on the support 24, for example, by photolithography. In FIG. 2B, regarding the convex portion 21 in the surface 23, its projected area on the support 24 is shown by a circle. The convex portions 21 form a lattice 25 on the surface 23, that is, the convex portions 21 are arrayed in a first direction (for example, X direction) and a second direction (for example, Y direction). The circle center nearly coincides with the lattice point of the lattice 25. The interval between two adjacent lattice points is preferably 1 to 100 μm, more preferably 5 to 20 μm. The circle diameter is preferably 1 to 100 μm, more preferably 5 to 20 μm on average. The convex portions 21 have a variation in size (in FIG. 2B, the circle area or circle diameter). Each size of the convex portions 21 is determined by, for example, a random number at each position of the convex portions 21.

In FIGS. 2A-2B, if the convex portions 21 have no variation in size, the antiglare film 20 satisfies two conditions that the concave or convex portions has a regular cross-sectional shape in the linear cross section of the antiglare film 20 and that the same cross-sectional shape of concave or convex portions as the regular cross-sectional shape repeatedly appears in the cross section parallel to the linear cross section, as a result, a color is viewed on the antiglare film 20 due to interference light.

In the antiglare film 20 of this embodiment, the convex portions 21 have a variation in size and the above-described conditions are not satisfied. Accordingly, when external light entering from the outside is reflected on the surface 23, the interference due to diffraction of the reflected light is resolved and the generation of a color due to interference of light can be suppressed. Furthermore, the light from outside or inside can be diffusively reflected or diffusively transmitted at the surface 23 and therefore, when the antiglare film 20 is laminated on the surface of a display, the viewer of the display can see a glareless and clear image.

In addition, unlike conventional techniques of forming the convex portions 21 at random positions, the convex portions 21 are formed at regular positions and a randomness of concave or convex portions are realized by varying the size of every convex portion 21, so that the design of the antiglare film 20 can be facilitated as compared with conventional antiglare films.

When the convex portions 21 have a variation in size, the size is not limited to the above-described area but may be the protrusion height in each of the convex part 21 or may be both the area and the protrusion height. Also, the shape of each convex portion 21 is not limited to a circular cone but may be an arbitrary polygonal cone.

Furthermore, in the description above, the convex portions 21 are formed in a lattice of a rectangular on the surface 23 (that is, the convex portions 21 are arrayed in a first direction and a second direction orthogonal to the first direction). The same effect can be obtained as long as there is provided an arrangement where a plurality of convex portions 21 are formed in a straight line extending to a specific direction (for example, X or Y direction) on the surface 23 and a plurality of the straight are arrayed in rows in the direction orthogonal to the specific direction. For example, in FIG. 2B, the convex array having a plurality of convex portions 21 (the portion surrounded by a dotted line) may be slipped off to the X direction by ½ pitch with respect to the next line, that is, the convex portions 21 are formed in a lattice of a parallelogram shape (that is, the convex portions 21 are arrayed in a first direction and a second direction not orthogonal to the first direction). The interval between convex portions in the convex array may not be constant in each convex array.

### THIRD EMBODIMENT

In this embodiment, the production method of the antiglare film 10 of the first embodiment is described.

The antiglare film 10 is produced by performing scanning with a laser light on a surface of the antiglare film such as polyimide film, wherein the scanning comprises: a main-scanning in a first direction; and a sub-scanning in a second direction orthogonal to the first direction; and controlling an output of the laser light when the main scanning is performed, so as to form the irregular surface upon irradiation (exposure) with the laser light. In the case of producing the antiglare film 10 shown in FIGS. 1A-1B, the specific direction is X direction or Y direction.

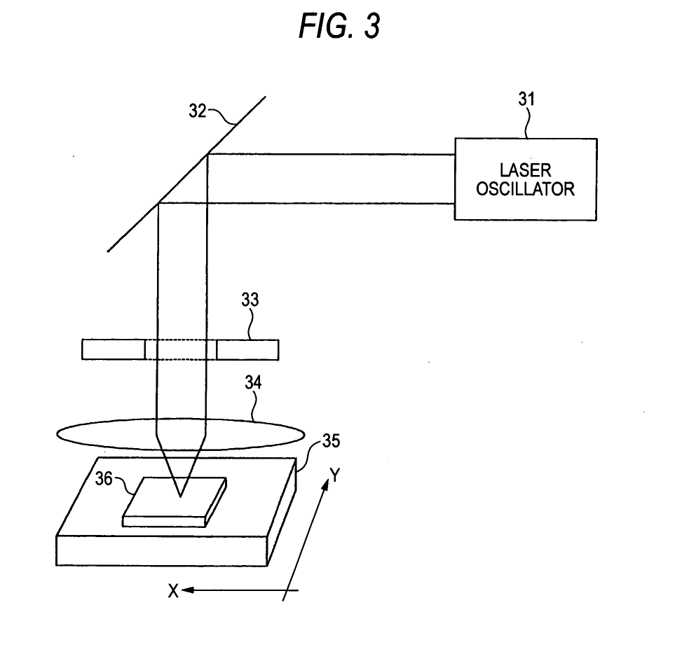

FIG. 3 shows an outline constitution of an example of the apparatus for use in the production of the antiglare film 10. The apparatus shown in FIG. 3 comprises a laser oscillator 31, a mirror 32, a mask 33 disposed in the light path for laser light and capable of changing the light-shielding range, a condenser lens 34 and an XY stage 35.

The laser oscillator 31 irradiates a laser light toward the mirror 32. The mirror 32 directs the irradiated laser light to a direction toward the condenser lens 34. The condenser lens 34 condenses the laser light at a surface of the film 36 on the XY stage 35. The XY stage 35 is movable to the X direction and the Y direction and by moving the XY stage 35 in the main-scanning direction and sub-scanning direction, the laser light is planarly scanned on the surface of the film 36 to form concave or convex portions on the surface of the film 36.

In this embodiment, at the production of the antiglare film 10, the irradiation area of the laser light (a beam diameter of the laser light output from the laser oscillator 31) is changed randomly at each irradiation position of the laser light (in FIG. 1B, each lattice point of the lattice 14), whereby the output of laser light is controlled. More specifically, a beam diameter of a laser light at each lattice point of the lattice 14 is determined according to a numerical value obtained by generating a random number at each lattice point of the lattice 14. Based on the values determined, the light-shielding range of the laser light is changed by the mask 33 at each lattice point to change in the beam diameter. Under such control, the laser light is irradiated on the film.

According to the production method of an antiglare film of this embodiment, the output of laser light can be controlled only by changing the beam diameter at each irradiation position while linearly moving the irradiation position of the laser light in the X direction and therefore, the irradiation position of laser light need not be accurately controlled as required in conventional techniques, so that the production of an antiglare film can be facilitated.

As for the output control of the laser light, other than the change in beam diameter of the laser light, the intensity of the laser light or the irradiation time of the laser light may be changed to impart a variation to the dimple depth in each concave portions, or at least one of the beam diameter of laser light, the intensity of laser light and the irradiation time may be changed.

### EXAMPLES

In this Example, tests 1 and 2 were performed under the following conditions.

By using YAG-FHG (wavelength: 266 nm) having a pulse width of 15 ns as the laser oscillator 31, irradiation was once performed per one irradiation position with a beam diameter φ of 15 μm and a fluence of 1 μJ/pulse.

As the film 36, a polyimide film (thickness: 200 μm) was used.

The condenser lens 34 was set such that the beam of the laser light forms a Gaussian beam profile through the condenser lens 34.

The irradiation position of the laser light (i.e., the lattice point) was set to 2,000 points at constant intervals of 15 μm in the X direction and 2,000 lines at intervals of 15 μm in the Y direction.

### Text 1

An antiglare film was produced under the above-described conditions by keeping constant the beam diameter of the laser light. The obtained film is designated as Film 1.

### Test 2

A random number was generated at each irradiation position of the laser light, the beam diameter at each irradiation position was decided based on the value obtained and while controlling the mask 33 based on the beam diameter determined, an antiglare film was produced. In this test, the beam diameter of the laser light at each irradiation position was decided such that the antiglare film finally obtained had a variation in diameter of the opening area of the concave portion (variation in opening area of the concave portion) and that the film had a standard variation of 5%, 10% or 15% in diameter (this had the same meaning as that the laser light had a standard variation of 5%, 10% or 15% in beam diameter).

In this Example, the standard variation a was found out by the following formula:

$$σ = \sqrt{\frac{1}{2000 \cdot 2000} \{ {\sum }_{i = 1}^{2000} {\sum }_{j = 1}^{2000} ( {P}_{ij} - \frac{1}{2000 \cdot 2000} {\sum }_{i = 1}^{2000} {\sum }_{j = 1}^{2000} {P}_{ij} ) \}}$$

wherein Pᵢⱼ represents a diameter of the opening area at the lattice point (i,j) of ith point in the X direction and jth point in the Y direction.

Out of the films obtained, the film produced by deciding the beam diameter to give a standard deviation of 5% was designated as Film 2, the film produced by deciding the beam diameter to give a standard deviation of 10% was designated as Film 3, and the film produced by deciding the beam diameter to give a standard deviation of 15% was designated as Film 4.

A bare fluorescent lamp (8,000 cd/m²) without a louver was reflected on these Films 1, 2, 3 or 4 and the degree of blur of the reflected fluorescent lamp image was evaluated with an eye to evaluate the antiglare property as one example of the control of light scattering direction. When the reflected fluorescent lamp image was viewed, the contour of fluorescent lamp was blurred in all films, revealing satisfactory antiglare property. But in Film 1, a color due to strong interference of light was seen. On the other hand, in Films 2, 3 and 4, the generation of a color due to interference of light was suppressed and as the numerical value of the standard deviation was larger, the generation of a color due to interference light was more successfully suppressed.

Incidentally, in the film prepared under the conditions that the standard deviation was less than 5%, a color due to strong interference of light was viewed similarly to Film 1. From this result, it was verified that when the standard deviation is 5% or more, an antiglare film capable of successfully suppressing the generation of a color due to interference of light can be produced.

The present application claims foreign priority based on Japanese Patent Application No. JP2003-294275 filed August 18 of 2003, the contents of which is incorporated herein by reference.

1. A method for producing an antiglare film having an irregular surface, which comprises:
performing scanning with a laser light on a surface of the antiglare film, wherein the scanning comprises: a main-scanning in a first direction; and a sub-scanning in a second direction orthogonal to the first direction; and
controlling an output of the laser light when the main scanning is performed, so as to form the irregular surface upon irradiation with the laser light,
wherein the controlling is performed by changing at least one of an irradiation area of the laser light, an intensity of the laser light, and an irradiation time of the laser light, randomly at each irradiation position of the laser light.

2. The method for producing an antiglare film as claimed in claim 1, wherein when the controlling is performed by changing the irradiation area of the laser light, the antiglare film has a standard variation of 5% or more in the irradiation area randomly changed.

3. The method for producing an antiglare film as claimed in claim 1, wherein the scanning is planar scanning.

4. An antiglare film having an irregular surface, which comprises a surface having a plurality of concave portions forming a lattice extending in a first direction and a second direction not parallel to the first direction, wherein each of the plurality of the concave portions have a variation in size.

5. The antiglare film as claimed in claim 4, wherein the lattice forms a rectangular shape.

6. The antiglare film as claimed in claim 4, wherein the lattice forms a parallelogram shape.

7. The antiglare film as claimed in claim 4, wherein each size of the plurality of the concave portions represents at least one of an opening area and a dimple depth in each of the plurality of the concave portions.

8. The antiglare film as claimed in claim 7, wherein when each size of the plurality of the concave portions represents the opening area in each of the plurality of the concave portions, the antiglare film has a standard variation of 5% or more in the opening area.

9. An antiglare film having an irregular surface, which comprises a surface having a plurality of convex portions forming a lattice extending in a first direction and a second direction not parallel to the first direction, wherein each of the plurality of the convex portions have a variation in size.

10. The antiglare film as claimed in claim 9, wherein the lattice forms a rectangular shape.

11. The antiglare film as claimed in claim 9, wherein the lattice forms a parallelogram shape.

12. The antiglare film as claimed in claim 9, wherein each size of the plurality of the convex portions represents at least one of a projected area and a protrusion height in each of the plurality of the convex portions.
